(19) United States
(12) Patent Application Publication
(10) Pub. No.: US 2008/0097839 A1
(43) Pub. Date: Apr. 24, 2008

(54) Method of Motivating Exposure to Advertisements

(76) Inventors: Assaf Koren, Herzeliya (IL); Oron Ben Grubner, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/573,206

(22) PCT Filed: Aug. 4, 2005
(86) PCT No.: PCT/IL05/00847

§ 371 Date: Feb. 4, 2007

Related U.S. Application Data
(60) Provisional application No. 60/598,850, filed on Aug. 5, 2004.

(51) Int. Cl. G06Q 30/00

(52) U.S. Cl. 705/14

(57) ABSTRACT

A provider prepares at least one quest including a plurality of tasks; offers, preferably for sale, advertising access in association with the tasks; and presents the quest(s) (20) to participants, with respective advertisements being presented in association with the tasks (24,26). The provider also provides incentives such as prizes for participating in the quests. Preferably, the tasks are linked. Preferably, the quest(s) is/are presented on a telecommunication network such as the Internet. The quests can be games, contests, tutorials or surveys. The prizes can be goods, services, discounts or publicity. Preferably, a narrative sequence of advertisements is presented along with the tasks of a quest.

### FIELD AND BACKGROUND OF THE INVENTION

The present invention relates to a method of doing business and, more particularly, to a method of presenting advertisements to potential consumers in a manner that gives the potential consumers an incentive to peruse the advertisements. The invention provides the advertisers with tools for controlling, at least in part, how, when, and especially where the potential consumers access the advertisements.

Internet advertising is well-known and ubiquitous. In the most common form of Internet advertising, an advertiser pays an owner of a Web page for permission to place an advertisement on the Web page. This form of advertising, like most forms of Web advertising, is passive, in the sense that a Web surfer who reaches that Web page does so irrespective of the advertisements that appear on the Web page. The advertiser may have advertisements on another Web page to which that Web page is linked; but the surfer has no incentive to proceed to the other Web page. Any exposure of the surfer to the advertiser's blandishments is purely incidental to the surfer's interest in the contents of the Web page.

Interactive Internet advertising, that involves active participation of a user, also is known. For example, it is known to include, in a Web page, an advertisement that includes a puzzle that, if solved correctly by a surfer who accesses the Web page, displays the advertisement. Such advertisements generally are entirely local to the Web pages in which they are included. Alternatively, an advertisement directs a surfer to another web page at which the interaction of the surfer with the advertisement concludes. The surfer is not induced to continue interacting with follow-up advertisements.

### SUMMARY OF THE INVENTION

The present invention provides incentives for Web surfers to actively follow a trail of Web pages that carry an advertiser's sequence of advertisements. This is accomplished by offering to Web users one or more “quests”. A “quest” is a set of tasks. Typically, each task is presented on its own Web page or set of Web pages, along with associated advertisements, either on the same Web pages or on Web pages that serve as gateways to the tasks. Participants are provided with incentives such as prizes for completing all the tasks. Participants thus are motivated to look at, or at least to be exposed to, the entire sequence of advertisements that is associated with the tasks of a quest.

Preferably, the tasks are linked tasks. After a participant in a quest has finished one task of the quest, the participant is directed to the next task of the quest, until the participant reaches the last task of the quest.

Therefore, according to the present invention there is provided a method of doing business, including the steps of: (a) preparing at least one quest, each at least one quest including a plurality of tasks; (b) offering advertising access associated with the tasks of the at least one quest; (c) presenting the at least one quest to a plurality of participants, with the tasks of each at least one quest being presented in association with respective advertisements obtained from the offering; and (d) for each at least one quest, providing an incentive for the participants to traverse the each quest.

Furthermore, according to the present invention there is provided a method of doing business, including the steps of: (a) preparing at least one quest, each at least one quest including a plurality of tasks; (b) offering advertising access associated with the tasks of the at least one quest; and (c) controlling exposure of a plurality of participants in the at least one quest to advertisements obtained from the offering.

In its most general sense, the present invention is a method by which a provider of quests does business. The provider starts by preparing one or more quests. Each quest includes a plurality of tasks. The provider of quests offers for sale advertising access associated with the tasks. Assuming that the provider of the quests succeeds in selling advertising access to quest sponsors, the provider of the quests then presents the quest(s) to participants in the quest(s), with the tasks of each quest being presented in association with respective advertisements. The provider of the quests thereby controls where, when and how the participants are exposed to the advertisements. The provider of the quests also provides, for each quest, an incentive for participants to participate in the quest by traversing the tasks of the quest.

Preferably, the tasks are linked. That the tasks are “linked” means that as soon as a participant in the quest completes a task, or alternatively when a participant who is presented with a task chooses to skip or postpone that task, that participant is presented with another task of the quest to perform, until the quest is completed. This linkage of tasks may be dynamic, in the sense that the tasks need not be presented to the participants in a particular, pre-arranged order. In addition, a participant who repeats a quest may be presented with tasks that are different from the tasks that were presented to the participant the previous time that the participant performed the quest.

Preferably, the quest(s) is/are presented to the participants via a telecommunication network such as an internet, an interactive television network or a cellular telephone network. By “internet” is meant a collection of interconnected computer networks. The best known internet, and a very important preferred telecommunication network of the present invention, is the worldwide Internet.

Preferred examples of quests include games, contests, tutorials and surveys.

Preferably, providing an incentive to participate in a quest includes offering a prize to at least one participant who performs the tasks of the quest in a prescribed manner. For example, a prize is offered to the participant who completes a quest first, or to the participant who completes a quest fastest during the time period that the quest is active. Preferred examples of prizes include goods, services, discounts and public notice of achievement. The terms “goods” and “services” are used herein as in the common phrase “goods and services”. A personal digital assistant is an example of a good that can be offered as a prize. An opportunity to meet a celebrity is an example of a service that can be offered as a prize. A meal for two in a restaurant combines a good (the meal) with a service (serving the meal).

Preferably, in at least one of the quests, a narrative sequence of the tasks' respective advertisements is presented sequentially along with the tasks.

Although the advertising access could be offered for free, for example as part of a promotion of the present invention, it is preferred that the advertising access be offered for sale.

From another point of view, the basic method of the present invention is a method by which the quest provider controls the exposure of a plurality of participants to advertisements that the quest provider obtains by offering for sale advertising access associated with the tasks of quests that the quest provider has prepared. Such control preferably is obtained by presenting the quest(s) to the participants with the tasks of the quest(s) being presented in association with respective advertisements. Preferably, the presentation of the quest(s) to the participants enables the quest provider to control the location (in real space and/or in cyberspace (e.g. at Web pages)) and timing of the exposure of the participants to the advertisements.

### BRIEF DESCRIPTION OF THE DRAWINGS

The invention is herein described, by way of example only, with reference to the accompanying drawings, wherein:

FIG. 1 illustrates the architecture of a system for implementing the present invention;

FIG. 2 is an example of a home page of the present invention that presents a set of quests;

FIG. 3 is a flow chart of a quest of the present invention from the point of view of a participant;

FIG. 4 is a high-level block diagram of preferred software architecture for implementing the present invention on the Internet.

### DESCRIPTION OF THE PREFERRED EMBODIMENTS

The present invention is of a method of presenting advertising to potential consumers that gives the consumers incentive to actually expose themselves to the advertisements. Specifically, the present invention can be used to present a narrative sequence of advertisements to users of the Internet.

The principles and operation of advertising according to the present invention may be better understood with reference to the drawings and the accompanying description.

The present invention motivates potential consumers to expose themselves to advertising by presenting the advertising in the context of one or more “quests”. Each quest consists of a linked series of tasks, at least some of which a participant in the quest must perform in order to complete the quest. When a participant in the quest starts the first task of the quest, and whenever a participant, having completed a task, proceeds to the next task, the task is presented to the participant along with advertising. That the tasks are presented to a participant in a particular sequence allows the advertiser to present corresponding advertisements in a corresponding sequence.

The provider of the quests makes money by selling advertising access (space and time to advertise) in the tasks. Optionally and preferably, part of the provider's income from the advertisers is used to offer prizes to the participants in the quests, as incentives to participate in the quests. For example, the first participant to complete a quest may receive a prize, or the participant who completes the quest the fastest while the quest is active may receive a prize. The prizes may be goods, services, combinations of goods and services, or discounts for purchase of goods and/or services. Or the provider of the quests may save money by providing publicity as prizes, for example, merely being listed publicly as the first or second or third participant to complete a quest. A sufficiently intriguing quest may not need prizes as incentives for potential consumers to participate.

From the point of view of a participant in a quest, the quest is a way to win a prize. From the point of view of a sponsor of a quest, a quest is a way to control where, when and how participants access the medium in which the quest is presented. The timing and location of the tasks, in real space or in cyberspace, is such that the participants should be exposed to the sponsor's advertisements in order to participate in the quest. The advertisements may be explicit or implicit. For example, merely requiring a participant to access a sponsor's home page in the course of a quest exposes the participant to the existence of the sponsor and the contents of the home page.

In its broadest sense, the present invention is not tied to any particular technology for presenting the quests to participants. Nevertheless, the present invention preferably is implemented by presenting the quests to participants via a telecommunication network. A very important preferred telecommunication network for this purpose (but by no means the only preferred telecommunication network for this purpose) is the Internet. Therefore the present invention is described herein in terms of the Internet.

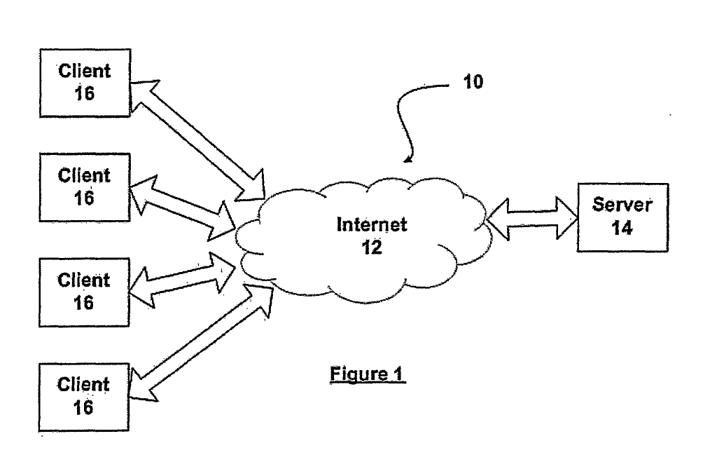

Referring now to the drawings, FIG. 1 illustrates the architecture of a system 10 for implementing the present invention. System 10 is based on the Internet 12 and includes a Web server 14 that presents quests, embodied in Web pages, to clients 16. Clients 16 are any platforms that support Web browsers, including, for example, personal computers and cellular telephones. Participants in the quests access the quests via their clients 16.

As noted above, the telecommunication network that is used to present the quests to the participants need not be the Internet. For example, an interactive television network can serve as such a telecommunication network, in which case element 12 of FIG. 1 represents the interactive television network, element 14 of FIG. 1 represents interactive broadcast television equipment such as a television studio and elements 16 of FIG. 1 represent participants' television sets. Alternatively, the telecommunication network can be a cellular telephony network, in which case element 12 of FIG. 1 represents the cellular telephony network, element 14 of FIG. 1 represents an interactive cellular telephone server such as a cellular telephone base station, and elements 16 of FIG. 1 represent the participants' cellular telephone handsets or personal digital assistants.

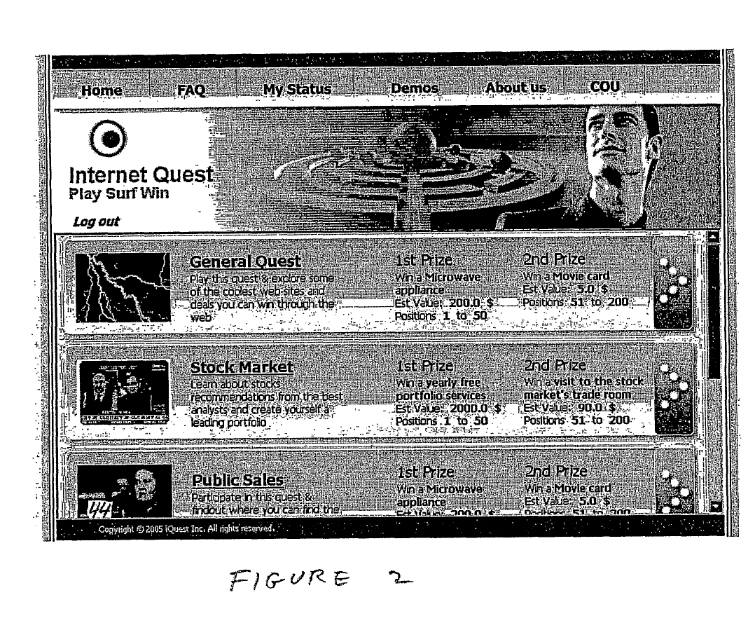

Returning to the Internet implementation of the present invention, the quests of the present invention are presented to the participants via Web pages that are coded in suitable source languages such as HTML and JAVA and then are stored at server 14. FIG. 2 is an example of a typical home page of the present invention that presents a set of quests. Hyperlinks to three quests are visible in this home page: “General Quest”, “Stock Market” and “Public Sales”. The scroll bar on the right provides access to more quests. A participant enters or re-enters a quest by clicking on the quest's icon or hyperlink. A participant also can re-enter a quest at the Web site of the last task performed by the participant, or at a Web site linked to that task, as described below.

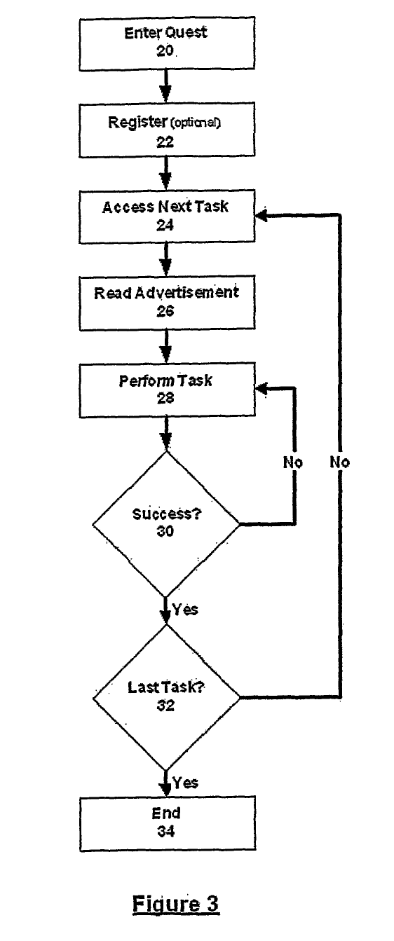

FIG. 3 is a flow chart of a typical quest of the present invention from the point of view of a participant. The participant selects a quest in block 20 and optionally registers in block 22. Registration enables the provider of the quest to communicate with the participant if it turns out that the participant deserves a prize. Registration also enables server 14 to track and record the progress of participants in the quest, so that a participant may stop participating at any time and resume later at the point at which s/he stopped. In block 24, the participant accesses the next task in the sequence of tasks of the quest. In block 26, the participant is exposed to the advertisement that is associated with the current task. From the point of view of the participant, block 26 is optional; but from the point of view of the advertiser, it is most preferred that the participant actually be exposed to, and pay attention to, the advertisement. Note that block 26 may precede or follow block 28. In block 28, the participant attempts to perform the task. In block 30, server 14 notifies the participant whether the participant has succeeded. For example, if the quest is a game, in block 30, if the participant has made an illegal move, server 14 tells the participant so. If the participant did not succeed, then the participant tries again in block 28. If the participant did succeed, then in block 32 server 14 directs the participant to the next task if there are more tasks in the quest, and otherwise ends the quest in block 34.

Requiring the participant to successfully complete a task before continuing to the next task, as in FIG. 3, is only one way to implement a quest. Alternatively, the participant is notified whether s/he has completed the task successfully and is allowed to proceed to the next task.

From the point of view of the provider of the quests, the registration in block 22 allows the provider to monitor participation in the quests. An advertiser can be billed in accordance with how many participants attempt the tasks in which the advertiser is advertising and in accordance with how much time the participants spend attempting the tasks. If registration information includes information about the participants such as participant demographics or participant preferences, the provider of the quests can give the advertisers feedback related to the effectiveness of their advertising campaigns, for example whether they are actually reaching their targeted audiences. Possession of such information about participants also enables the quest provider to target advertisements to specific participants during the course of a quest.

A quest can be, for example, a game, a collection of games, a contest, a tutorial or a survey. In a single-game quest, each task is a move of the game. If the game is a game such as backgammon or chess that has different levels of proficiency, the participant is allowed, at the start of the quest, to select a proficiency level. The prize for beating server 14 at the game then preferably is in accordance with the requested proficiency level. In a multi-game quest, each task is either a complete game or a portion of a game. In a contest, every task is another step of the contest. An example of a contest is presented below. In a tutorial, the participant is a student, and each task tests the student's comprehension of whatever it is that the quest is supposed to be teaching the student. In a survey, each task is a question of the survey. A quest may also include more than one kind of task, for example games together with a survey.

A quest usually is limited in duration (e.g. one day or two weeks); but some quests, such as tutorials, are open-ended. The tasks of a quest also may be time-bound. For example, the instructions of an Internet task may include an instruction such as “go to www.xyz.com today at 8:00 PM”.

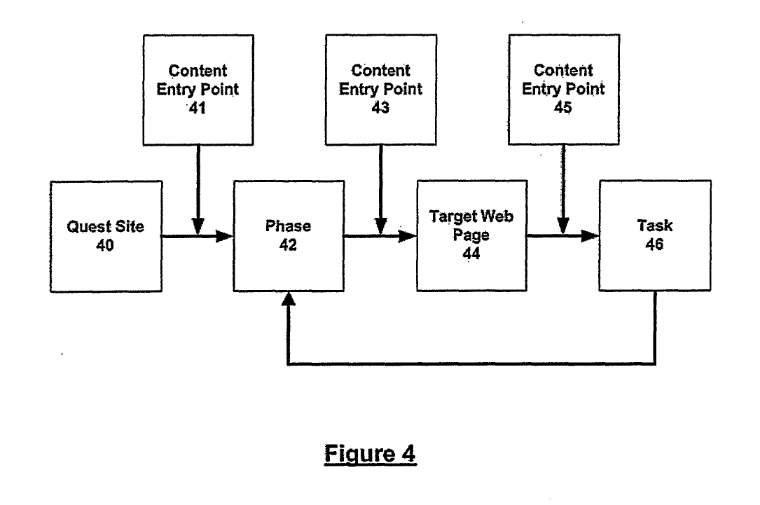

FIG. 4 is a high-level block diagram, of one preferred software architecture for implementing the present invention on the Internet. The boxes in FIG. 4 represent code such as HTML code for presenting a quest to participants. Quest site 40 is code for presenting a quest. The code of quest site 40 could be contained entirely in the code of the quest provider's home page, or could include code of a separate Web page that presents details of the quest. Clicking on the appropriate icon or hyperlink in the pages supported by code 40 to start or resume the tasks of the quest activates phase 42. Phase 42, which may or may not display a Web page of its own, is code for managing metadata associated with a task. For example, phase 42 keeps track of which task the participant is to perform next, and also links that task to the associated advertisement. Phase 42 also may support dynamic task linking as described in the “contest” example below. In this architecture, the advertisement itself takes the form of an advertiser's Web page, whose code is in target web page block 44. An icon for the quest's task is added to the advertiser's Web page. If phase 42 does not display a Web page of its own, then starting or resuming the quest sends the participant directly to the advertiser's Web page. If phase 42 does display a Web page of its own, then that Web page includes a link to the advertiser's Web page. Clicking on the task icon in the advertiser's Web page directs the participant to the task itself, whose code is in block 46. Completing the task, skipping the task or postponing the task returns control to phase 42 to set up the next task.

Also shown in FIG. 4 are boxes 41, 43 and 45 that represent content that the quest provider optionally inserts into the participant's transition from quest site 40 to phase 42, from phase 42 to target Web page 44 or from target Web page 44 to task 46.

An example of a contest of the present invention now will be presented. The object of the contest is to identify landmarks in Manhattan. For this purpose, task code 46 creates and displays, for each task, a Web page that includes a picture of a landmark and a set of fields for entering the street address of the landmark. Task code 46 allows a participant to enter a proposed location, and tells the participant whether the participant is right. The participant is allowed to keep trying until either the participant succeeds in identifying the location of the landmark, in which case task code 46 branches to phase 42 for the next landmark, or the participant gives up. Of course, the participant is free to re-enter the quest later. Upon re-entering the quest, clicking on the task icon in the advertiser's Web page directs the participant to the landmark task at which the participant left the quest.

Several features of the present invention are illustrated by this example. One feature is that the linking of the tasks is dynamic, in the sense that the landmarks need not be presented to all participants in the same order. Phase 42 includes code for selecting landmarks in a random order. Of course, phase 42 keeps track of which landmarks each participant has successfully identified. Another feature is that the tasks need not be entirely virtual, but could include real world activities. For example, a participant in the landmark contest is free to walk around Manhattan looking for landmarks. A third feature is that a participant may choose to skip a landmark and return to that landmark later. A fourth feature is that, depending on the difficulty of a quest, a quest provider has the option of not requiring that all the tasks be completed in order to win a prize. In the present example, if no participant has succeeded in identifying all the landmarks by the time the contest ends, the quest provider is free to award the winning prize to the contestant who has correctly identified the most landmarks.

A fifth feature is that the provider of the quests solicits sponsorship for its various quests from potential sponsors who are suitable for those quests. In the present example, suitable sponsors for a contest to identify Manhattan landmarks include restaurants and theaters located in Manhattan. Correspondingly, suitable prizes for successful and/or rapid completion of this quest include a free meal for two at a Manhattan restaurant or tickets for two to a Broadway show.

One example of content that can be inserted as part of this exemplary quest, for example at content entry point 43, is a short video clip of a Manhattan restaurant owned by a sponsor.

Another preferred software architecture for implementing the present invention on the Internet dispenses with target web page code 44 and instead places the advertisements as banners on the Web pages of the tasks, as in the prior art. This architecture is particularly useful for tasks such as surveys in which participants go relatively quickly from one task to the next. This allows the advertisements in successive task Web pages to form a narrative sequence, in the style of the Burma Shave advertisements of the twentieth century.

(For those of you who were born after about 1960: The Burma Shave Company used to plant sets of five signs, about 100 to 200 meters apart, along roadways in the United States. Each sign bore part of a short poem advertising Burma Shave™ shaving cream. For example:

Sign 1: WITHIN THIS VALE

Sign 2: OF TEARS AND SIN

Sign 3: YOUR HEAD GOES BALD

Sign 4: BEFORE YOUR CHIN

Sign 5: BURMA SHAVE)

A participant in such a survey encounters similar advertisement segments for twenty-first century products while answering the survey questions in the same way as a twentieth century motorist encountered Burma Shave™ signs.

While the invention has been described with respect to a limited number of embodiments, it will be appreciated that many variations, modifications and other applications of the invention may be made.

What is claimed is:

1. A method of doing business, comprising the steps of:
(a) preparing at least one quest, each said at least one quest including a plurality of tasks;
(b) offering advertising access associated with said tasks of said at least one quest;
(c) presenting said at least one quest to a plurality of participants, with said tasks of each said at least one quest being presented in association with respective advertisements obtained from said offering; and
(d) for each said at least one quest, providing an incentive for said participants to traverse said each quest.

2. The method of claim 1, wherein said tasks are linked.

3. The method of claim 1, wherein said at least one quest is presented to said participants via a telecommunication network.

4. The method of claim 3, wherein said telecommunication network is an internet.

5. The method of claim 3, wherein said telecommunication network is an interactive television network.

6. The method of claim 3, wherein said telecommunication network is a cellular telephone network.

7. The method of claim 1, wherein at least one said quest includes a game.

8. The method of claim 1, wherein at least one said quest includes a contest.

9. The method of claim 1, wherein at least one said quest includes a tutorial.

10. The method of claim 1, wherein at least one said quest includes a survey.

11. The method of claim 1, wherein said providing of said incentive includes offering a prize to at least one of said participants who performs said tasks of said each quest in a prescribed manner.

12. The method of claim 11, wherein said prize includes a good.

13. The method of claim 11, wherein said prize includes a service.

14. The method of claim 11, wherein said prize includes a discount.

15. The method of claim 11, wherein said prize includes public notice of achievement.

16. The method of claim 1, wherein, for at least one said quest, a narrative sequence of said respective advertisements is presented sequentially along with said tasks.

17. The method of claim 1, wherein said offering includes offering said advertising access for sale.

18. A method of doing business, comprising the steps of:
(a) preparing at least one quest, each said at least one quest including a plurality of tasks;
(b) offering advertising access associated with said tasks of said at least one quest; and
(c) controlling exposure of a plurality of participants in said at least one quest to advertisements obtained from said offering.

19. The method of claim 18, wherein said controlling is effected by presenting said at least one quest to said participants, with said tasks of each said at least one quest being presented in association with respective said advertisements.

20. The method of claim 19, wherein said presenting of said tasks includes instructing said participants how to access each said task.

21. The method of claim 18, wherein said controlling includes controlling location of said exposure of said participants to said advertisements.

22. The method of claim 18, wherein said controlling includes controlling timing of said exposure of said participants to said advertisements.

23. The method of claim 18, further comprising the step of:
(d) for each said at least one quest, providing an incentive for said participants to traverse said each quest.
